(19) United States
(12) Patent Application Publication
(10) Pub. No.: US 2017/0255181 A1
(43) Pub. Date: Sep. 7, 2017

(54) MEASUREMENT APPARATUS, SYSTEM, MEASUREMENT METHOD, AND ARTICLE MANUFACTURING METHOD

(71) Applicant: CANON KABUSHIKI KAISHA, Tokyo (JP)

(72) Inventor: Akihiro Yamada, Sakura-shi (JP)

(21) Appl. No.: 15/446,248

(22) Filed: Mar. 1, 2017

(30) Foreign Application Priority Data
Mar. 2, 2016 (JP) 2016-040313

(51) Int. Cl. G05B 19/401; H04N 5/247

(52) U.S. Cl. CPC G05B 19/401; H04N 5/247

(57) ABSTRACT

A measurement apparatus including an imaging device configured to perform imaging of an object to output image information, and perform measurement of arrangement of the object in a state where at least one of the object and the imaging device is moving, comprising: a processor configured to obtain information of the arrangement based on the output image information, wherein the processor is configured to perform a process of synchronization between the imaging and measurement of a position of the at least one.

### BACKGROUND OF THE INVENTION

Field of the Invention

The present invention relates to a measurement apparatus, a system, a measurement method, and an article manufacturing method.

Description of the Related Art

In recent years, complicated tasks that thus far people have performed (for example, assembling an industrial product) are in the process of coming to be performed instead by robots. A control of a robot hand that performs grasping an object and the like can be performed based on the measurement of the arrangement (for example, position and posture) of the object that is performed by a measurement apparatus supported by the robot hand. An image measurement apparatus disclosed in Japanese Patent No. 5740649 obtains information on a focusing position of an imaging means by taking into account an imaging period of time.

If a relative position of the robot hand and the object changes, accurate synchronization between the timing at which the robot hand measures the position (arrangement) of the robot hand itself and the timing at which the measurement apparatus performs measurement (imaging) is important. The apparatus disclosed in Japanese Patent No. 5740649 corrects a focus position based on a deviation amount between the center of the imaging period of time and the timing of obtaining the positional information, and thus is disadvantageous in terms of the time and accuracy for obtaining the focus position.

### SUMMARY OF THE INVENTION

The present invention provides, for example, a measuring apparatus in measurement of arrangement of an object that is moving relative thereto.

The present invention is a measurement apparatus that includes an imaging device configured to perform imaging of an object to output image information, and perform measurement of arrangement of the object in a state where at least one of the object and the imaging device is moving, comprising: a processor configured to obtain information of the arrangement based on the output image information, wherein the processor is configured to perform a process of synchronization between the imaging and measurement of a position of the at least one.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a system that includes a measurement apparatus and a robot according to a first embodiment.

FIG. 2 illustrates details of the measurement apparatus.

FIG. 3 is a schematic diagram illustrating a configuration of a robot.

FIG. 4 illustrates a timing at which the robot obtains positional information and a timing at which the measurement apparatus performs measurement.

FIG. 5 is a flowchart illustrating a measurement method for obtaining information relating to an arrangement.

FIG. 6 illustrates details of the measurement apparatus according to a second embodiment.

FIG. 7 illustrates a timing at which the robot obtains positional information and a timing at which the measurement apparatus performs measurement.

FIG. 8 is a flowchart illustrating a method of measuring information relating to an arrangement according to the second embodiment.

### DESCRIPTION OF THE EMBODIMENTS

Hereinafter, embodiments of the present invention will be described with reference to the drawings and the like.

### First Embodiment

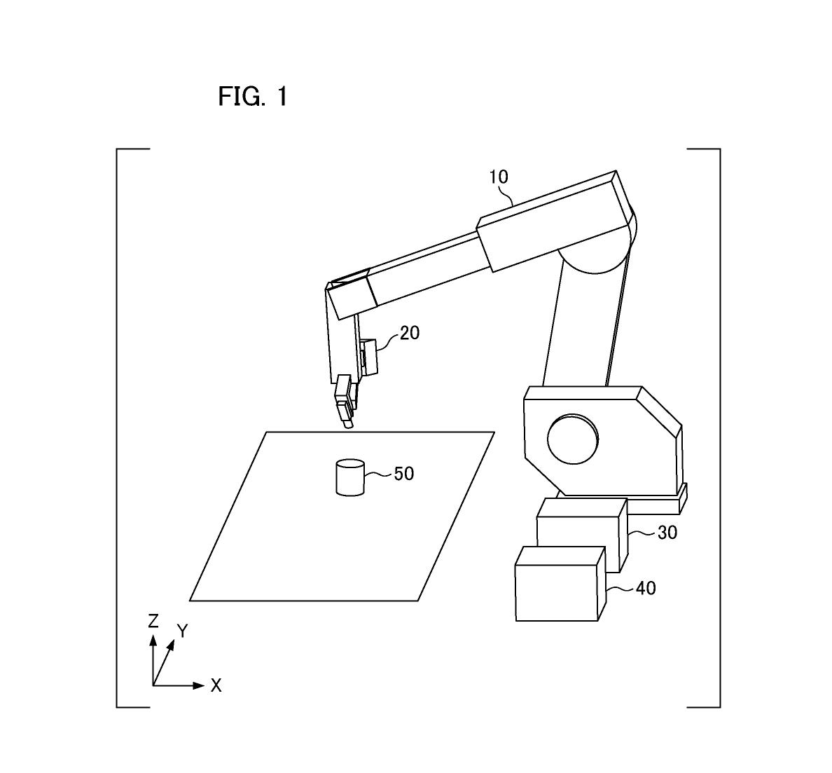

FIG. 1 is a schematic diagram illustrating a configuration of a system that includes a measurement apparatus 20 and a robot 10 of the present embodiment. The measurement apparatus 20 is controlled by a measurement controller 40. The measurement apparatus 20 is mounted on an end of the robot 10, and a robot controller 30 controls a robot arm based on the result for the measurement of an object to be measured (object) 50 by the measurement apparatus 20. The measurement by the measurement apparatus 20 is performed in a state in which at least one of the measurement apparatus 20 and the object to be measured 50 is moving. Additionally, the robot controller 30 gives an instruction to start measurement (trigger) to the measurement controller 40 in accordance with the position of the robot 10. The position of the robot 10 is measured by a device (not illustrated) that is included in the robot controller 30. Here, the object to be measured 50 is, for example, parts or a mold for manufacturing the parts. In the drawing, a plane on which the object to be measured 50 is placed is defined as the XY plane and a direction that is perpendicular to the XY plane is defined as the z direction.

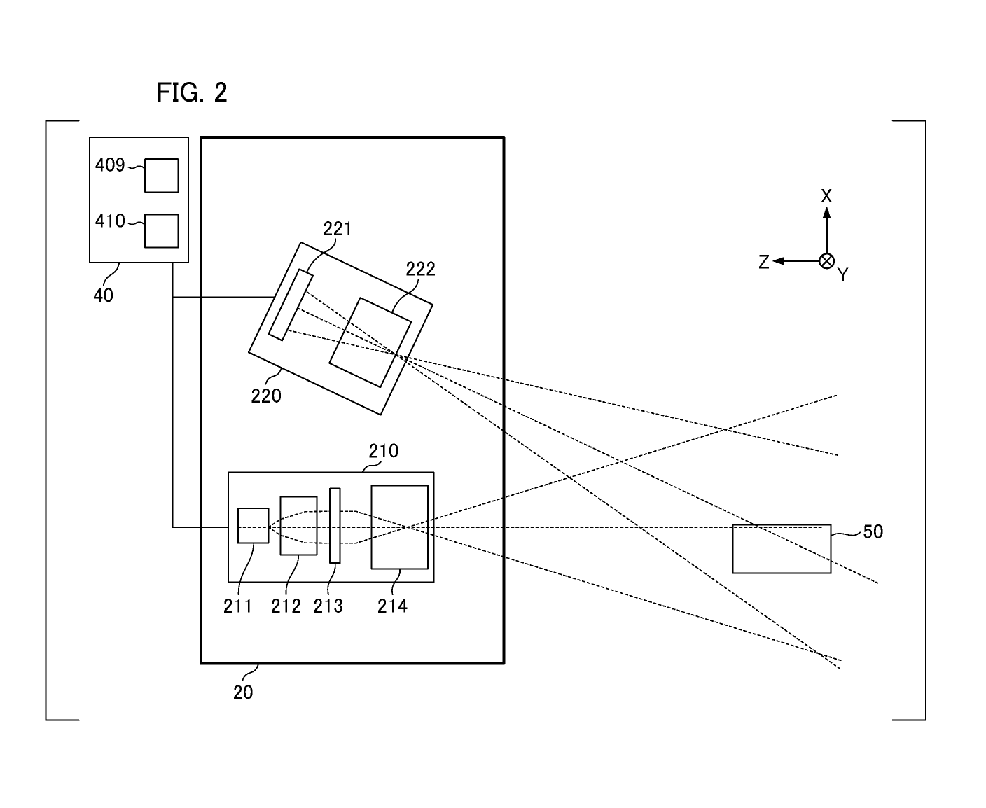

FIG. 2 illustrates details of the measurement apparatus 20. The measurement apparatus 20 includes an illumination device 210 and an imaging device 220. The illumination device 210 has a light source (for example, LED) 211, an illumination optical system 212, a mask 213, and a projection optical system 214. The imaging device 220 includes an imaging element (camera) 221 and an imaging optical system 222. The measurement controller 40 measures the arrangement (for example, position and posture) of the object to be measured 50 by fitting a captured image (image information) output from the imaging device 220 to a three-dimensional CAD model of the object to be measured 50 that has been produced in advance. In the present embodiment, as shown in FIG. 2, an illumination direction of the illumination produced by the illumination device 210 toward the object to be measured 50 and an imaging direction by the imaging device 220 are different from each other, and the measurement controller 40 obtains coordinates (distance information) of the object to be measured 50 from the captured image based on the principle of triangulation. The model fitting is performed based on the distance information that has been obtained.

A case is assumed in which the measurement is performed during the change of a relative positional relation between the robot 10 (measurement apparatus 20) and the object to be measured 50, and thus, in the present embodiment, information relating to the arrangement of the object to be measured 50 is measured from one captured image by taking into account a measurement accuracy. Accordingly, the illumination device 210 projects, for example, a patterned light of a dot line pattern onto the object to be measured 50. The light source 211 starts light emission based on a trigger from the robot controller 30. The illumination optical system 212 uniformly illuminates the mask 213 with a light beam emitted from the light source 211 (for example, Koehler illumination). The mask 213 is the one onto which a pattern corresponding to the pattern light to be projected to the object to be measured 50 is drawn, and in the present embodiment, the dot line pattern is formed, for example, by chromium-plating a glass substrate. However, the mask 213 may be configured by a DLP (digital light processing) projector and a liquid crystal projector, which can generate any pattern. In this case, it is possible to specify a pattern to be illuminated by the measurement controller 40. The projection optical system 214 is an optical system that projects the pattern drawn on the mask 213 onto the object to be measured 50. The imaging optical system 222 is an optical system for forming an image of the pattern that has been projected onto the object to be measured 50 on the imaging element 221. The imaging element 221 is an element for imaging a pattern projected image, and, for example, a CMOS sensor, a CCD sensor, and the like can be used.

Here, the dot line pattern is a periodic line pattern in which bright portions formed by bright lines and dark portions formed by dark lines are alternately arranged (stripe pattern). Dots are provided, for example, between the bright portions and the dark portions so as to cut the bright portions in a direction in which the bright portions extend on the bright lines. Dots are identification parts for distinguishing the bright lines from each other. Since the positions of the dots are different on each bright line, an index is given that indicates which line on the pattern each bright line that has been projected corresponds to based on the coordinate (position) information of the detected dots, and then the identification between each bright line that has been projected is allowed.

The measurement controller 40 has an instruction unit 409 and a calculation unit (processor) 410. The instruction unit 409 instructs the illumination device 210 to start light emission upon receiving a trigger from the robot controller 30. Additionally, the instruction unit 409 also provides an instruction for a timing at which the imaging device 220 starts imaging. The instruction that specifies the pattern of the mask 213 can also be transmitted to the illumination device 210. The calculation unit 410 performs an image process for the captured image, calculation of the distance information by using the principle of triangulation, model fitting, and calculation of a timing for which the instruction unit 409 has provided instructions (process for synchronization).

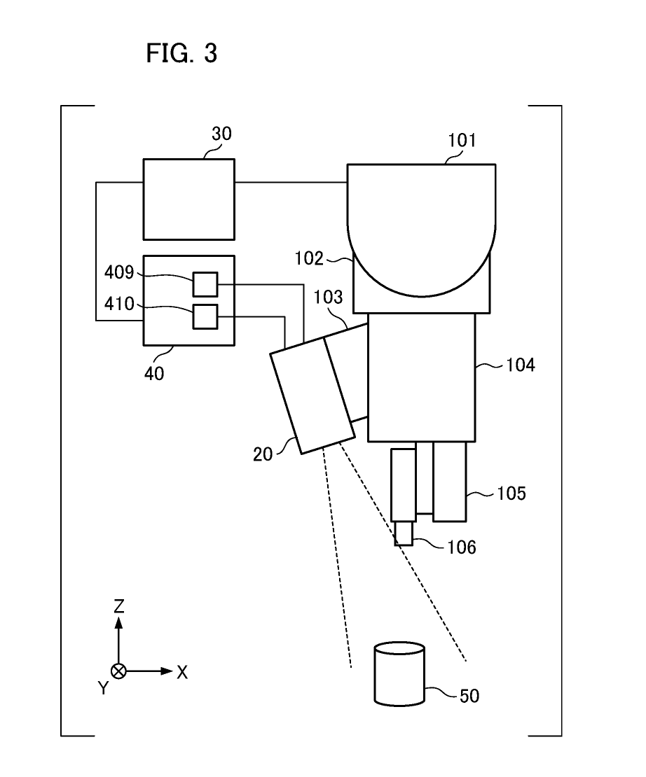

FIG. 3 is a schematic diagram illustrating a configuration of the robot 10. The robot 10 has a plurality of movable axes constituted by a rotational or translational moving axis. In the present embodiment, a six-degree-of-freedom robot configured by a six-axis rotating movable axis is used. The robot 10 has a drive unit (arm) 101, a flange 102, a mount portion 104 that mounts the measurement apparatus 20 via an attaching stay (support unit) 103, a hand 105, and a grasping part 106. The information relating to the arrangement of the object to be measured 50 that has been calculated by the calculation unit 410 is transmitted to the robot controller 30. The robot controller 30 provides an operation instruction to the robot 10 based on this information.

Here, the mount portion 104 is fixed to the flange 102 and the position coordinates in a flange coordinate system do not change. Additionally, the measurement apparatus 20 is rigidly attached to the mount portion 104 via the attaching stay 103. Specifically, a relative relation between the measurement apparatus 20 and the flange 102 is strictly defined.

A description will be given of the relative positional relation between the robot 10 and the measurement apparatus 20. The position coordinates of the flange 102, which serves as positional information for the robot 10 in a world coordinate system, is set in the robot controller 30. Additionally, relative position coordinates between the measurement apparatus 20 and the robot 10 (flange 102) are set in the robot controller 30. This setting value can be obtained by obtaining a relative position and posture of the measurement apparatus 20 in the flange coordinate system of the flange 102 by using pre-calibration and the like, and the value does not change hereafter. This positional information can be stored in a storage unit (not illustrated) in the robot controller 30.

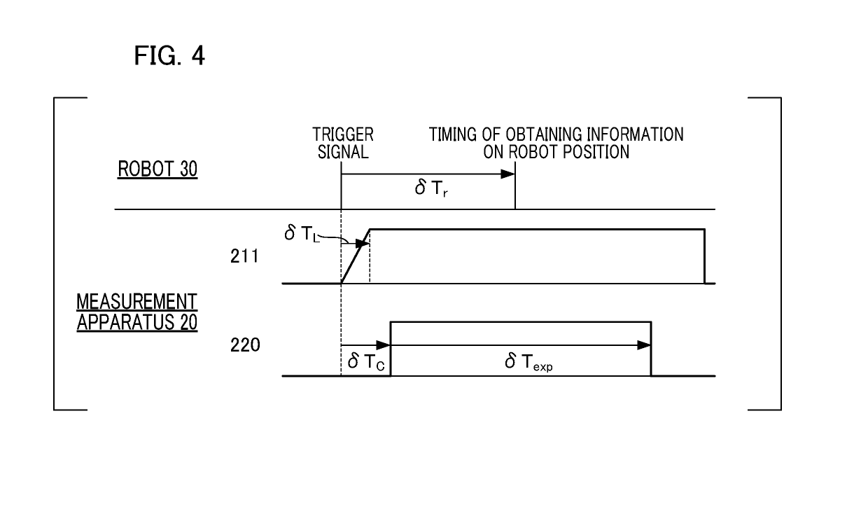

FIG. 4 illustrates the timing by which the robot obtains the positional information and the timing by which the measurement apparatus performs measurements. The horizontal axis shows a time. First, the robot controller 30 issues a trigger to the instruction unit 409. The instruction unit 409 instructs the light source 211 to start light emission upon receiving the trigger. The light source 211 requires a rise time δT_{L} to reach an output value for a desired light amount. Additionally, the instruction unit 409 transmits an instruction according to which the imaging device 220 starts imaging for an exposure time (time for imaging) δTₑₓₚ at the exposure start time, which is after a predetermined delay time δT_{C} from the point in time when the trigger has been issued. The delay time δT_{C} and the exposure time δTₑₓₚ have been stored in advance in the storage unit (not illustrated) in the measurement controller 40. Here, the imaging is performed after the illumination by the illumination device 210, and thus, it is necessary to set δT_{C} equal to or more than δT_{L}. However, the delay time δT_{C} is not necessarily determined by δT_{L} alone. The exposure time δTₑₓₚ is, for example, set to be short in a case where the object to be measured 50 is a material having a high reflectance, such as a metal, while the exposure time δTₑₓₚ is set to be long in a case where the object to be measured 50 is a material having a low reflectance (for example, a black material). As δTₑₓₚ is set longer, the synchronization accuracy of the timing by which the robot controller 30 obtains the positional information and the timing by which the imaging device 220 performs imaging is more important.

In contrast, the robot controller 30 obtains the positional information of the robot 10 (flange 102) after δTᵣ of the trigger-transfer. δTᵣ is determined (specified) based on the imaging delay time δT_{c} and the exposure time δTₑₓₚ. Assuming that a moving velocity of the robot 10 during the exposure time δTₑₓₚ serves as a constant velocity motion, the result for the measurement of the information relating to the arrangement of the object to be measured 50 to be obtained by the measurement controller 40 serves as information relating to the arrangement of the object to be measured 50 in the exposure time δTₑₓₚ/2. Accordingly, δTᵣ is set such that the robot controller 30 obtains the positional information of the robot 10 at the midpoint of the exposure time δTₑₓₚ. That is, the specified δTᵣ is δT_{c}+ (δTₑₓₚ/2).

In the present embodiment, the measurement controller 40 calculates δTᵣ and transfers the result to the robot controller 30. However, it may be possible that the measurement controller 40 transfers the delay time δT_{c} and the exposure time δTₑₓₚ to the robot controller 30, the robot controller 30 calculates δTᵣ(=δT_{c}+(δTₑₓₚ/2)), and consequently, the measurement controller 40 obtains the calculated result from the robot controller 30.

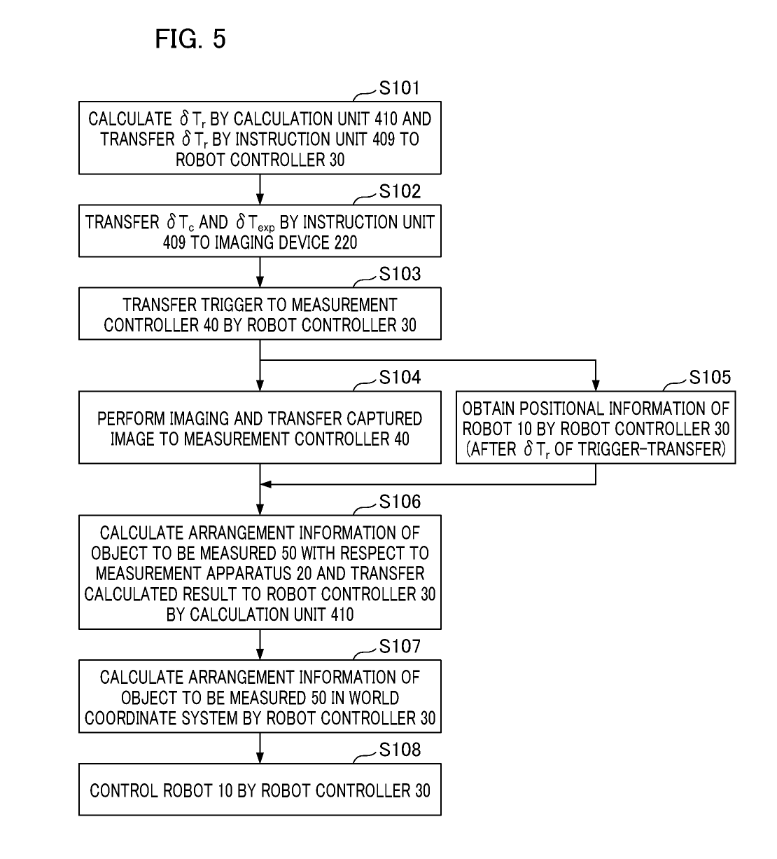

FIG. 5 is a flowchart illustrating a measurement method of the information relating to the arrangement in the present embodiment. In step S101, the calculation unit 410 calculates time δTᵣ by which the robot controller 30 obtains the position of the robot 10 based on the delay time δT_{c} and the exposure time δTₑₓₚ, and the instruction unit 409 transfers δTᵣ to the robot controller 30. In step S102, the instruction unit 409 transfers the delay time δT_{c} and the exposure time δTₑₓₚ, which have been stored in the storage unit (not illustrated) inside of the measurement controller 40 in advance, to the imaging device 220, and an imaging condition of the imaging device 220 is set. In step S103, the robot controller 30 generates a trigger and transfers it to the measurement controller 40. In step S104, the measurement controller 40 causes the illumination device 210 to start the output of the illumination upon receiving the transferred trigger. Additionally, the measurement controller 40 causes the imaging device 220 to start imaging based on the imaging condition that has been set. After the completion of the imaging, the imaging device 220 transfers the obtained image to the measurement controller 40.

In parallel with step S104, in step S105, the robot controller 30 obtains the positional information of the robot 10 (flange 102) in the world coordinate system, at intervals of δTᵣ transferred in step S101, after the trigger-transfer. In step S106, based on the transferred image, the calculation unit 410 calculates the distance information, performs model fitting, and calculates the information relating to the arrangement of the object to be measured 50 (coordinate information), which serves the measurement apparatus 20 as a reference. The calculated result is transferred to the robot controller 30. In step S107, the robot controller 30 converts the coordinate information, which serves the measurement apparatus 20 as a reference, into the world coordinate system. That is, the information relating to the arrangement of the object to be measured 50 in the world coordinate system is calculated. Specifically, the information is calculated based on the positional information of the robot 10 and the information relating to the arrangement of the object to be measured 50 with respect to the measurement apparatus 20 by using the relative positional information of the measurement apparatus 20, which serves the positional information of the robot 10 as a reference. In step S108, the robot controller 30 controls the robot 10 based on the information relating to the arrangement of the object to be measured 50 in the world coordinate system (information relating to the arrangement after conversion into the world coordinate system) calculated in step S107.

As described above, the measurement apparatus (measurement method) of the present embodiment can appropriately adjust δTᵣ, δT_{c}, and δTₑₓₚ, so that the synchronization of the measurement of the position of the robot (=the position of the measurement apparatus) and the imaging of the object by the measurement apparatus can conveniently be performed with a high accuracy. In particular, it is advantageous in a case where the relative positional relation rapidly changes by the movement of both the robot and the object to be measured at a high velocity (relative velocity V), and in a case where the image is offset equal to or more than a value that is obtained by multiplying the pixel pitch L of the camera by an imaging magnification β during the exposure time Tₑₓₚ of the camera. Expressed as a formula, it is the case of V×Tₑₓₚ≧L×β. Additionally, it is advantageous in a case of handling a plurality of objects to be measured that each have different reflectance. According to the present embodiment, it is possible to provide a technique that is advantageous in the measurement of the arrangement of the object that is moving relative to the measurement unit.

### Second Embodiment

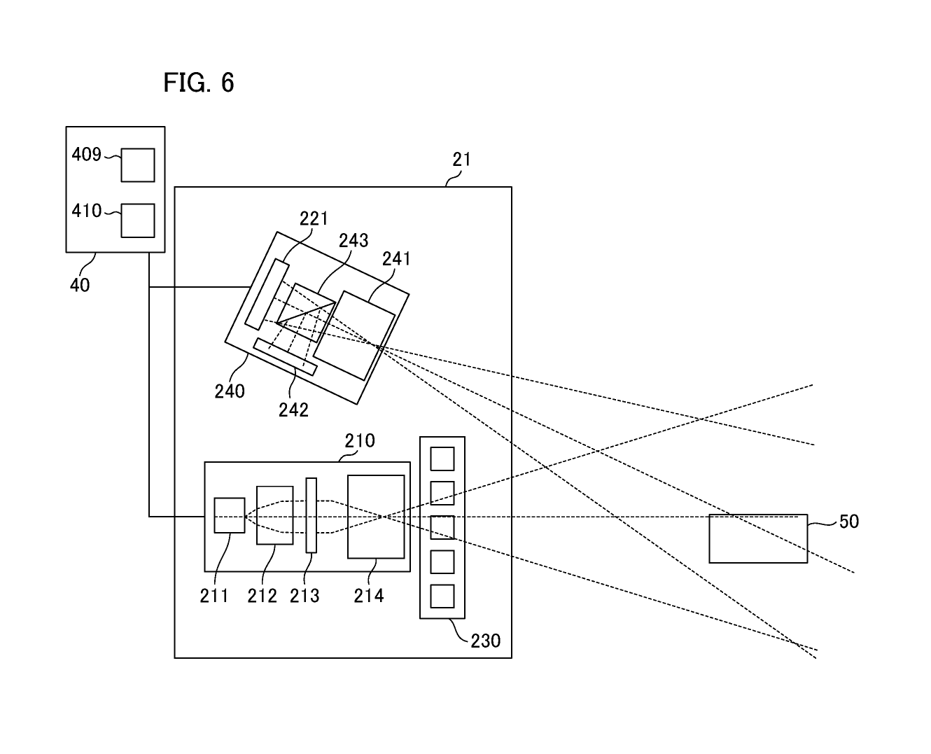

FIG. 6 illustrates details of the measurement apparatus according to the present embodiment. The same reference numerals are given to the components that are common to those in the measurement apparatus 20 of the first embodiment, and the descriptions of those components are omitted. A measurement apparatus 21 of the present embodiment includes a uniform illumination unit 230 and an imaging device 240. The measurement apparatus 21 is an apparatus that measures the information relating to the arrangement of the object to be measured 50 by simultaneously obtaining a grayscale image in addition to the distance image obtained by the measurement apparatus 20 of the first embodiment, and performing model fitting by using the two images simultaneously.

The imaging device 240 includes an imaging optical system 241, two imaging elements, 221 and 242, and a wavelength division element 243. The imaging optical system 241 captures a pattern image projected to the object to be measured 50 and a grayscale image, and the pattern image (distance image) and the grayscale image are separated to the imaging elements 221 and 242 by the wavelength division element 243, and then an image is formed.

In the present embodiment, an edge corresponding to a contour or a ridge of the object is detected from the grayscale image, and the edge is used for calculating the information relating to the arrangement, serving as a characterizing portion. The grayscale image is obtained by the uniform illumination unit 230 and the imaging device 240. The imaging device 240 images the object to be measured 50 that has been uniformly illuminated by the uniform illumination unit 230. The uniform illumination unit 230 is ring illumination obtained by arraying a plurality of LED light sources that emits a light of a wavelength that is different from the illumination device 210 in a ring, and can uniformly illuminate the object to be measured 50 with the ring illumination so that, as far as possible, a shadow is not formed. Note that the present invention is not limited to this ring illumination, and coaxial epi-illumination, dome illumination, or the like may be adopted.

The calculation unit 410 calculates the edge by performing an edge detecting process with respect to the obtained grayscale image. At this time, the image process may be performed in a manner similar to the distance image. As an edge detection algorithm, the Canny method and various other methods are available, and any method can be used.

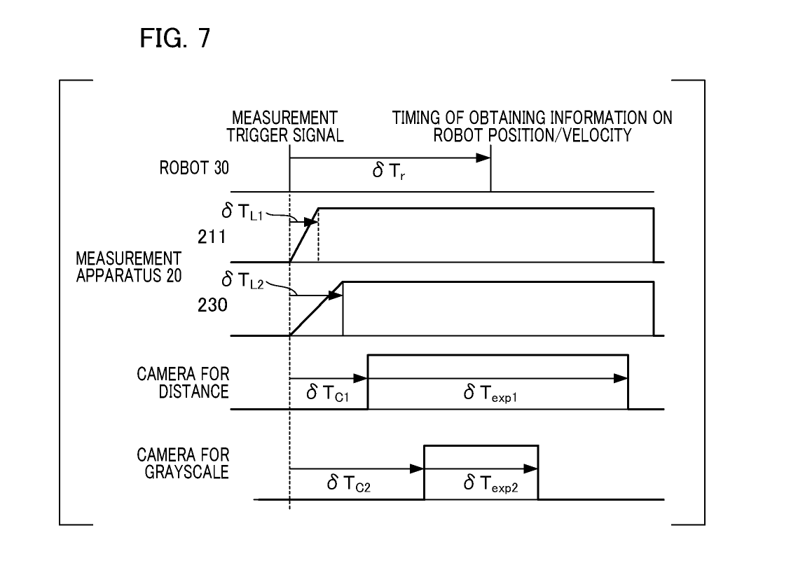

FIG. 7 illustrates the timing by which the robot according to the present embodiment obtains the positional information and the timing by which the measurement apparatus performs measurement. First, the robot controller 30 issues a trigger that indicates the measurement start to the instruction unit 409. The instruction unit 409 instructs the light source 211 for distance image obtainment to start light emission upon receiving the trigger. The light source 211 requires rise time δT_{L1} to reach an output value of a desired light amount. Similarly, the instruction unit 409 instructs the uniform illumination unit 230 for grayscale image obtainment to start light emission upon receiving the trigger. The uniform illumination unit 230 requires rise time δT_{L2} to reach an output value of a desired light amount. Additionally, the instruction unit 409 transmits an instruction in which the imaging device 220 starts imaging after a predetermined delay time δT_{C1} for the exposure time δTₑₓₚ₁. Similarly, the instruction unit 409 transmits an instruction in which the imaging element 221 starts imaging after a predetermined delay time δT_{C2} for the exposure time δTₑₓₚ₂. The delay times δT_{c1} and δT_{c2}, and the exposure times δTₑₓₚ₁ and δTₑₓₚ₂ have been stored in the storage unit (not illustrated) inside of the measurement controller 40 in advance. Note that the relation between the delay time and the time required for the rise of the light source is similar to that in the first embodiment. That is, the relation of δT_{c1}≧δT_{L1} and δT_{c2}≧δT_{L2} is set.

The exposure times δTₑₓₚ₁ and δTₑₓₚ₂ are individually adjusted based on the difference in output between the light source 211 for distance image obtainment and the uniform illumination unit 230 for gray image obtainment. Here, depending on the wavelength dependency of the reflectance of the object to be measured 50, the exposure times δTₑₓₚ₁ and δTₑₓₚ₂ do not necessarily coincide with each other. Here, due to the reasons to be described below, the setting is performed such that time Tₖ₁ obtained by adding the delay time δT_{c1} to half of the exposure time δTₑₓₚ₁ is equal to time Tₖ₂ obtained by adding the delay time δT_{c2} to half of the exposure time δTₑₓₚ₂. Since the exposure time is determined by a reflection characteristic of the object to be measured 50, the setting is performed by individually adjusting the delay times δT_{c1} and δT_{c2}.

In contrast, the robot controller 30 obtains the positional information of the robot 10 (flange 102) after δTᵣ of the trigger-transfer. δTᵣ is determined based on the imaging delay times δT_{c1} and δT_{c2} and the exposure times δTₑₓₚ₁ and δTₑₓₚ₂. Assuming that a moving velocity of the robot 10 during the exposure time is a constant velocity motion, the result for the measurement of the information relating to the arrangement of the object to be measured 50 to be obtained by the measurement controller 40 serves as information relating to the arrangement of the object to be measured 50 in the exposure times δTₑₓₚ₁/2 and δTₑₓₚ₂/2. Accordingly, the setting is performed such that δTᵣ is equal to time Tₖ₁ obtained by adding the delay time δT_{c1} to half of the exposure time δTₑₓₚ₁ and time Tₖ₂ obtained by adding the delay time δT_{c2} to half of the exposure time δTₑₓₚ₂. At this time, by taking into account the sampling timing for obtaining the robot position of the robot controller 30, it may be possible to enable synchronization with a high accuracy by adjusting the delay times δT_{c1} and δT_{c2}. The calculation of δTᵣ may be calculated at the measurement controller 40 or may be calculated at the robot controller 30, similar to the first embodiment.

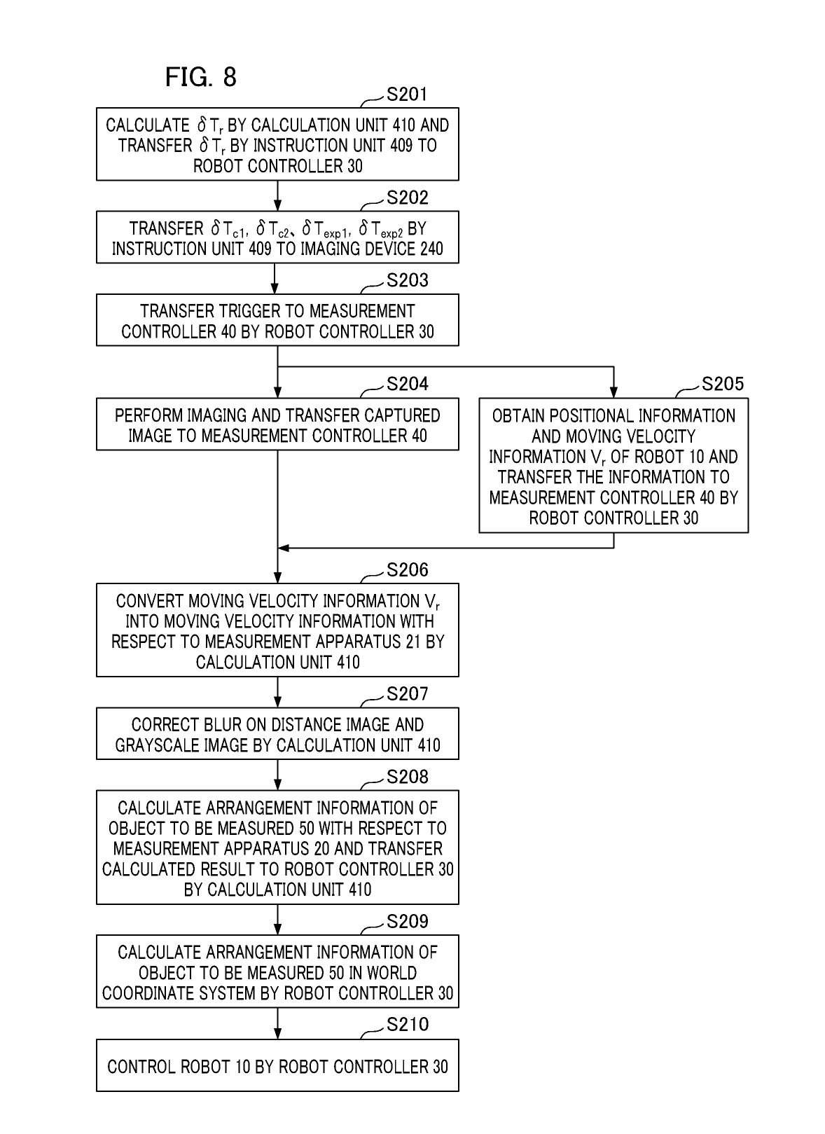

FIG. 8 is a flowchart illustrating a measurement method of the information relating to the arrangement according to the present embodiment. In step S201, the calculation unit 410 calculates the time δTᵣ by which the robot controller 30 obtains the position of the robot 10 from the delay times δT_{c1} and δT_{c2}, and the exposure times δTₑₓₚ₁ and δTₑₓₚ₂, and the instruction unit 409 transfers δTᵣ to the robot controller 30. In step S202, the instruction unit 409 transfers the delay times δT_{c1} and δT_{c2}, and the exposure times δTₑₓₚ₁ and δTₑₓₚ₂, which have been stored in the storage unit (not illustrated) inside of the measurement controller 40 in advance, to the imaging device 240, and then the imaging condition of the imaging device 240 is set.

In step S203, the robot controller 30 generates a trigger and transfers it to the measurement controller 40. In step S204, the measurement controller 40 causes the illumination device 210 and the uniform illumination unit 230 to start the output of the illumination upon receiving the transferred trigger. Additionally, the measurement controller 40 causes the imaging device 240 to start imaging based on the imaging condition that has been set. After the completion of the imaging, the imaging device 240 transfers the obtained image to the measurement controller 40. In parallel with step S204, in step S205, after the trigger-transfer, the robot controller 30 obtains the positional information of the robot 10 (flange 102) in the world coordinate system and moving velocity information Vᵣ at intervals of δTᵣ transferred in step S201. The obtained information is transferred to the measurement controller 40.

In step S206, the calculation unit 410 converts the moving velocity information Vᵣ that has been transferred into moving velocity information with respect to the measurement apparatus 21. In step S207, the calculation unit 410 performs blur correction on the distance image and the grayscale image that have been obtained based on the moving velocity information that was obtained by conversion in step S206. In step S208, the calculation unit 410 calculates the distance information and the edge information based on the image on which blur correction has been performed, performs model fitting, and obtains the information on the arrangement (for example, position and posture) of the object to be measured 50 with respect to the measurement apparatus 20. The obtained information is transferred to the robot controller 30. In step S209, the robot controller 30 calculates the information relating to the arrangement of the object to be measured 50 in the world coordinate system. Specifically, the information is calculated based on the positional information of the robot 10 and the information relating to the arrangement of the object to be measured 50 with respect to the measurement apparatus 20 by using the relative positional information of the measurement apparatus 20 and the robot 10, which has been obtained in advance. In step S210, the robot controller 30 controls the robot 10 based on the information relating to the arrangement of the object to be measured 50 in the world coordinate system calculated in step S209.

As described above, compared to the first embodiment, the measurement apparatus (measurement method) of the present embodiment can obtain the information relating to the arrangement of the object to be measured with a higher accuracy by using the distance image and the grayscale image and correcting blur of the distance image and the grayscale image caused by the movement. According to the present embodiment, it is also possible to provide a technique having the same effect as in the first embodiment.

Note that for the calculation of δTᵣ, it may be possible for the measurement controller 40 to provide the delay time δT_{c} and the exposure time δTₑₓₚ for specifying the point in time for the synchronization to the robot controller 30, and the robot controller 30 calculates δTᵣ. Additionally, it may be possible for the measurement controller 40 to obtain δTᵣ from the robot controller 30 in a state in which δTᵣ has been stored in the robot controller 30 in advance, and the delay time δT_{c} and the exposure time δTₑₓₚ are calculated. At this time, the delay time δT_{c} may be determined together with δTᵣ in a state in which the exposure time δTₑₓₚ has been determined in advance.

Additionally, in the first embodiment, the blur correction of the captured image may be added to the steps. In the above embodiments, a configuration in which a stationary object to be measured is measured by the measurement apparatus mounted on the robot that is driven is used. However, for example, a measurement apparatus may be used in which an object to be measured is mounted on a drive mechanism that is movable like a belt conveyor and a stage while holding an object to be measured, and from a fixed position, images the drive mechanism from above. In this case, the position of the measurement apparatus can be measured by a device provided in the drive mechanism.

The blur correction on the captured image performed by the calculation unit 410 is performed by, for example, deconvolution of an image to which the Richardson-Lucy method is applied. Additionally, the calculation unit 410 may correct an image by performing image compression based on the moving velocity information of the robot at the time of imaging. As another correction means, a method in which image compression is performed at different compression ratios in a periodic direction of a pattern imaged in the captured image can also be applied. Specifically, a plurality of compressed images are generated by, for example, including a compressed image 1 in which binning is performed on every two pixels in the pattern period direction with respect to the imaging pixel, a compressed image 2 in which binning is performed on every three pixels in the pattern period direction with respect to the imaging pixel, and a compressed image 3 in which binning is performed on every four pixels in the pattern period direction with respect to the imaging pixel. A method of calculating a distance value by selecting a compressed image in which a pattern contrast increases for each position of a pattern on which each distance point is calculated may be used.

The distance sensor is not limited to the active stereo method as described above, and may be a passive type in which the depth of each pixel is calculated by triangulation based on two images photographed by a stereo camera. In addition, any device that measures the distance images will not impair the essence of the present invention. The device used as the robot 10 may be, for example, a vertically articulated robot having a seven-axis rotation axis, a scalar robot, or a parallel link robot. In addition, any type of robot may be used as long as it has a plurality of movable axes constituted by a rotational or translational moving axis and can obtain motion information.

### Embodiment According to an Article Manufacturing Method

The measurement apparatus according to the embodiments described above is used in an article manufacturing method. The article manufacturing method includes a process of measuring a position of an object using the measurement apparatus, and a process of processing the object on which measurement is performed in the process. The processing includes, for example, at least one of machining, cutting, transporting, assembly, inspection, and sorting. The article manufacturing method of the embodiment is advantageous in at least one of performance, quality, productivity, and production costs of articles, compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-040313 filed on Mar. 2, 2016, which is hereby incorporated by reference herein in its entirety.

What is claimed is:

1. A measurement apparatus that includes an imaging device configured to perform imaging of an object to output image information, and perform measurement of arrangement of the object in a state where at least one of the object and the imaging device is moving, the apparatus comprising:
a processor configured to obtain information of the arrangement based on the output image information,
wherein the processor is configured to perform a process of synchronization between the imaging and measurement of a position of the at least one.

2. The measurement apparatus according to claim 1,
wherein the processor is configured to perform the process of synchronization with respect to a predetermined time point in a period of the imaging.

3. The measurement apparatus according to claim 2,
wherein the processor is configured to provide, to a device that performs the measurement of the position, first information for specifying the time point.

4. The measurement apparatus according to claim 3,
wherein the first information includes information indicating a time from issuing of a trigger for the measurement of the arrangement to the time point.

5. The measurement apparatus according to claim 2,
wherein the processor is configured to obtain second information for specifying the time point from the device that performs the measurement of the position.

6. The measurement apparatus according to claim 5,
wherein the second information includes information indicating a time from issuing a trigger for the measurement of the arrangement to the time point.

7. The measurement apparatus according to claim 3,
wherein the device that performs the measurement of the position is included in a device that supports and moves the measurement apparatus.

8. The measurement apparatus according to claim 3,
wherein the device that performs the measurement of the position is included in a device that holds and moves the object.

9. The measurement apparatus according to claim 1,
wherein the processor is configured to obtain the arrangement of the object in a world coordinate system based on information of the arrangement that has been obtained based on the image information in a coordinate system on the measurement apparatus, and information obtained by the measurement of the position.

10. The measurement apparatus according to claim 1, further comprising, other than the imaging device,
another imaging device configured to perform another imaging of the object to output image information,
wherein the processor is configured to perform a process of synchronization between the other imaging and the measurement of the position.

11. The measurement apparatus according to claim 1,
wherein relation of V×Tₑₓₚ≧L×β is satisfied, where V denotes a relative velocity between the imaging device and the object, Tₑₓₚ denotes an exposure time of the imaging, L denotes a pixel pitch of the imaging device, and β denotes an imaging magnification of the imaging device.

12. A system comprising:
a measurement apparatus defined in claim 1; and
at least one of a device that supports and moves the measurement apparatus and a device that holds and moves an object.

13. A measurement method of performing measurement of arrangement of an object in a state where at least one of an imaging device that performs imaging of the object to output image information and the object is moving, comprising steps of:
performing a process of synchronization between the imaging and measurement of a position of the at least one,
obtaining information of the arrangement based on the output image information obtained via the process of the synchronization.

14. A method of manufacturing an article, the method comprising steps of:
performing measurement of arrangement of an object using a measurement apparatus; and
performing processing of the object, of which the measurement has been performed, to manufacture the article,
wherein the measurement apparatus includes an imaging device configured to perform imaging of an object to output image information, and performs measurement of arrangement of the object in a state where at least one of the object and the imaging device is moving, and includes:
a processor configured to obtain information of the arrangement based on the output image information,
wherein the processor is configured to perform a process of synchronization between the imaging and measurement of a position of the at least one.

15. A method of manufacturing an article, the method comprising steps of:
performing measurement of arrangement of an object using a system; and
performing processing of the object, of which the measurement has been performed, to manufacture the article,
wherein the system includes:
a measurement apparatus; and
at least one of a device that supports and moves the measurement apparatus and a device that holds and moves the object,
wherein the measurement apparatus includes an imaging device configured to perform imaging of an object to output image information, and performs measurement of arrangement of the object in a state where at least one of the object and the imaging device is moving, and includes:
a processor configured to obtain information of the arrangement based on the output image information,
wherein the processor is configured to perform a process of synchronization between the imaging and measurement of a position of the at least one.

16. A method of manufacturing an article, the method comprising steps of:
performing measurement of arrangement of an object using a measurement method; and
performing processing of the object, of which the measurement has been performed, to manufacture the article,
wherein the measurement method performs measurement of arrangement of an object in a state where at least one of an imaging device that performs imaging of the object to output image information and the object is moving, and includes steps of:
performing a process of synchronization between the imaging and measurement of a position of the at least one,
obtaining information of the arrangement based on the output image information obtained via the process of the synchronization.

17. A measurement apparatus that includes an imaging device supported by a moving device and performing imaging of an object to output image information, and performs measurement of arrangement of the object in a state where the imaging device is moving, the apparatus comprising:
a processor configured to obtain information of the arrangement based on the output image information,
wherein the processor is configured to provide, to the moving device, first information for specifying a predetermined time point in a period of the imaging to perform synchronization between the imaging and measurement, by the moving device, of a position of the imaging device.

18. The measurement apparatus according to claim 17, wherein the first information includes information indicating a time from issuing, from the moving device, of a trigger for the measurement of the arrangement to the time point.

19. The measurement apparatus according to claim 17, further comprising, other than the imaging device, another imaging device configured to perform another imaging of the object to output image information,
wherein the processor is configured to perform a process of synchronization between the other imaging and the measurement of the position.
